(19) United States
(12) Patent Application Publication
(10) Pub. No.: US 2007/0136134 A1
(43) Pub. Date: Jun. 14, 2007

(54) Method and System for Generating Revenue Using a Multi-Screen Display System

(76) Inventor: Jerry Moscovitch, Toronto (CA)

Correspondence Address: MASS ENGINEERED DESIGN INC., 474 WELLINGTON STREET WEST, TORONTO, ON, M5V-1E3, CA

(21) Appl. No.: 11/609,532

(22) Filed: Dec. 12, 2006

Related U.S. Application Data
(60) Provisional application No. 60/749,160, filed on Dec. 12, 2005.

(51) Int. Cl. G06Q 30/00

(52) U.S. Cl. 705/14

(57) ABSTRACT

A method of generating advertising revenue using a multi-screen display system is provided. The method includes providing a multi-screen display system having a plurality of screens, and dedicating and advertisement screen, chosen from the plurality of screens, for showing an advertisement. The method also includes showing an advertisement on at least part of the advertisement screen for at least some of the time the advertisement screen is on or in use.

### CROSS-REFERENCE TO RELATED APPLICATION

This application claims priority to provisional application 60/749,160, filed Dec. 12, 2005.

### FIELD OF THE INVENTION

This invention relates to multi-screen display systems, and in particular to a method and system for generating advertising revenue using multi-screen display systems.

### BACKGROUND OF THE INVENTION

The number of multi-monitor or multi-screen computer display systems has increased in recent years as computer users in various industries adapt their use to new environments. For example, a multi-monitor display system can be used to create the illusion of a larger screen, thereby allowing a securities trader to view a large single spreadsheet over several displays. Alternately, the trader may view individual applications on individual screens (for example, one screen may display a Web Browser, a second a new service and a third a spreadsheet of financial data).

Individuals working with still or moving images, such as graphics artists, video or film editors or medical diagnosticians may also use multi-monitor display systems. A given image may be viewed across several screens or two images maybe be viewed side-by-side. (such as two x-ray images used to assess the extent to which a broken bone has healed).

Aside from these applications, there are other uses of multi-screen display systems that involve unorthodox ways of generating revenue.

### SUMMARY OF THE INVENTION

Described herein is a system and method for generating advertising revenue using a multi-screen display system. The method includes providing a multi-screen display system having a plurality of screens, and dedicating an advertisement screen, chosen from the plurality of screens, for showing an advertisement. The method also includes showing an advertisement on at least part of the advertisement screen for at least some of the time the advertisement screen is on or in use.

To prevent an unauthorized person from removing the advertisement, a password can be issued. Only the holder of the password would be authorized to remove, or in any way interfere with advertisement.

Also described herein is a method of generating advertisement revenue that includes providing a multi-screen display system to a call center having at least one salesperson for selling a product. The method further includes showing an advertisement for the product to at least one salesperson of the call center on at least one screen of the multi-screen display system, the “advertisement screen.”

Also described herein is a method of generating advertising revenue using a multi-screen display system. The method includes installing a multi-screen display system, which has a plurality of screens, at a retail store, and dedicating an advertisement screen, chosen from the plurality of screens, for showing an advertisement. An advertisement is shown to persons in the retail store on at least part of the advertisement screen for at least some of the time the advertisement screen is on or in use. In one embodiment, the retail store sells multi-screen display systems, and the multi-screen display screen having the advertisement screen is a demonstration model. The advertiser pays an advertisement fee to retailer for allowing the advertisement to be shown therein. The manufacturer may also receive a portion of this fee in return for selling multi-screen display systems to the retailer at a discount.

The multi-screen display system may be connected to a computer network. Instructions can be sent via the network to the multi-screen display system to control the content of the advertisement.

### BRIEF DESCRIPTION OF THE DRAWINGS

FIGS. 1A and 1B show a front view and a back view of a three-screen display system, respectively.

FIGS. 2A-C show components of a three-screen display system.

FIG. 3 shows an advertising system having a multi-screen display system in communication with a computer network.

### DESCRIPTION OF THE INVENTION

Multi-screen displays afford an opportunity to generate advertising revenue by dedicating at least one of the screens (the “advertisement screen(s)”) to advertising. In considerations for displaying an advertisement on the at least one screen, an advertiser pays an advertisement fee to an entity (or more than one entity), hereinafter referred to as an advertisement revenue beneficiary. Thus, the multi-screen system is used to generate advertisement revenue for the beneficiary. Dedicating the advertisement screen can include preventing and unauthorized person from removing the advertisement from the advertisement screen for the at least some of the time during which the advertisement is displayed. In addition, by issuing a password, a person can be authorized to remove the advertisement from the advertisement screen. Several models are described below that employ multi-screen display systems for generating advertising revenue for the beneficiary.

One model involves a distribution channel in which a manufacturer sells a product to distributor, who then sells the product to a reseller, who finally sells the product to an end-user. In such a distribution channel, the distributor can run one or more call centers for the purpose of selling the product to resellers. In particular, in each call center several salespersons are employed to sell the product to resellers by telephone.

These salespersons often have a lot of discretion regarding the particular products that are offered to the reseller. Salespersons can promote one particular product over a competing product based on several factors. For example, the salesperson may be aware of a special promotion being offered by a manufacturer. Or, the salesperson may be paid a commission based on sales of a particular product. The salesperson may also be aware of some advantages of a particular product over a competing product, and naturally may extol these advantages to the reseller.

Because a salesperson has a large influence on the particular product sold, manufacturers often target salespersons with certain marketing efforts. It is a common practice, for example, for a manufacturer to offer workshops to salespersons working in the distributor call center to educate the salespersons about the advantages of its products.

The principles of the present invention help manufacturers target call center salespersons by exploiting the fact that multi-screen display systems are often used in call centers. Such systems are often present in call centers because a call center salesperson has to have access to a lot of information while talking to a reseller on the telephone. Thus, one screen can be used to provide information about the reseller, such as past purchases, special needs, profiles, etc., while another screen can display reseller catalog information pertaining to a type of product. Recognizing the desire of manufacturers to target call center salespersons and the ubiquity of multi-screen displays in distributor call centers, a method of generating advertising revenue using at least one of the multi-screens is now described.

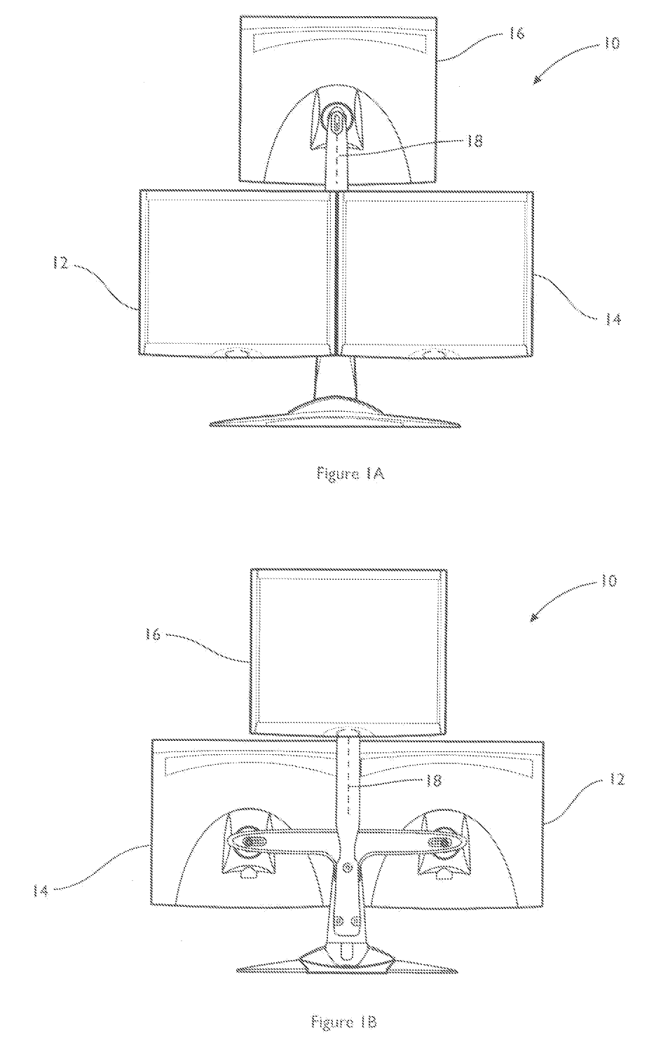

Referring to FIGS. 1A and 1B, a front view and a back view of a three-screen display system 10 is shown, respectively. More generally, the display system can possess any number of screens greater than one. The three-screen display system 10 includes two work screens 12 and 14, and one advertisement screen 16. In the embodiment shown, the top advertisement screen 16 faces in the opposite direction that the work screens 12 and 14 face. The advertisement screen 16 can be rotatable about an axis 18. In particular, the advertisement screen 16 can be rotated by hand, or perhaps by a motor (not shown). In the latter case, the advertisement screen can be made to constantly rotate by the motor.

The advertisement screen 16 can be completely dedicated to advertising or only partially dedicated advertisement, both physically and temporally. In other words, advertisements can be shown on a part or the entire screen for some or all of the time the screen is on or in use. Parts of the screen not used for advertising can be used for any other purpose by a user of the system 10. Likewise, when no advertisement is being shown, the user may also use the advertisement screen 16 for whatever purpose.

It should be understood that in some embodiments of the multi-screen display systems contemplated by the inventor, more than one screen might be an advertisement screen. For example, in a four-screen display system, two of the four screen can be dedicated to advertising.

When used to generate revenue in the distribution model described above, the display system 10 can be installed in a distributor call center and the advertisement can be targeted to the salespersons therein. In particular, the advertisement screen 16 can show advertisements of manufacturer products that can influence the selling habits of the salespersons. Thus, if the distributor sells cell phones from several manufacturers, a particular manufacturer of Cell Phone A may pay to place an advertisement promoting Cell Phone A with the hope that the advertisement will convince a salesperson in the distributor call center to sell more Cell Phone A's to reseller, or, perhaps, to an end user. The advertisement can be any type of advertisement that can be displayed on a computer screen and can optionally be accompanied by audio. Moreover, the advertisement can be aimed at one or more salespersons within viewing (or hearing) range. In particular, the advertisement can be aimed at the salesperson using the system 10 (in which case the advertisement screen preferably points in the same direction as the work screens, at least for part of the time) and/or any of the other salespersons in the call center.

The manufacturer of Cell Phone A would normally be the entity identified above as the advertiser who pays advertising fees to a beneficiary for the privilege of showing the advertisement. The beneficiary can be the distributor, who allows the advertisements to be shown in the distributor call center, and who typically owns the multi-screen display system 10. The beneficiary may instead or in addition be the manufacturer of the multi-screen display system 10. In this latter scenario, the manufacturer of the multi-screen display system 10 may enter into an agreement with the distributor of cell phones who wishes to purchase multi-screen display systems for use in their call center. Such an agreement would call for dividing advertising revenue generated by the advertisement screen between the manufacturer of the multi-screen display system 10 and the distributor. In consideration therefor, the manufacturer of the multi-screen display system 10 would agree to sell the display system 10 to the distributor at a reduced price, perhaps even at no cost.

A second model for generating advertising revenue by using multi-screen display systems involves the use of these systems in retail establishments. At a retail store selling computer hardware and software, a multi-screen display system may be on display in a showroom frequented by customers buying computer equipment. The computer display system can be powered during business hours to be available for demonstration to potential customers. According to the principles of the present invention, at least one of the multi-screens in the display system can be dedicated to showing advertisements. The remaining screen(s) can be accessed by the customer for demonstration purposes.

In addition to, or instead of displaying such a multi-screen display system for the purpose of selling the system, a retailer may choose to display such a system, even if it is not for sale—for example, the multi-screen display system may be in use for some internal purpose—to generate advertising revenue.

The advertiser who products are shown on the at least one advertisement screen pays a fee for this service to a beneficiary, which can include the retailer. If the advertiser is also a distributor or manufacturer selling goods to the retailer, this fee may be in the form of a discount on the price that the retailer pays the distributor or manufacturer for the goods. For example, the advertiser can be a software company selling Software A at the retail establishment. In exchange for advertising Software A on The advertisement screen of the multi-screen display system to target customers at the retail establishment, the software company may agree to sell the software to the retailer at a discount.

In addiction to the retailer, the beneficiary can include the distributor or manufacturer of the multi-screen display systems. Thus, if the retailer agrees to share some of the advertising revenue generated by using the multi-screen display system, the distributor or manufacturer of the multi-screen display system in turn may sell the multi-screen display system to the retailer at a discount.

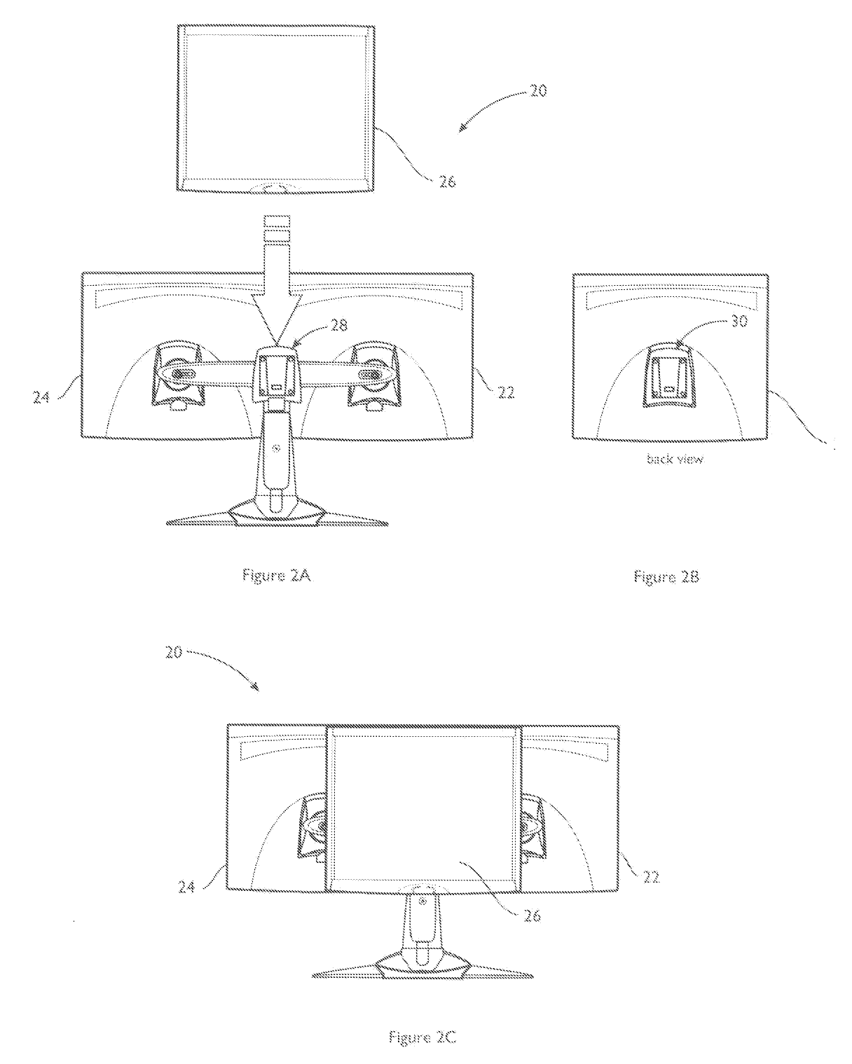

Referring to FIGS. 2A, 2B and 2C, components of another embodiment of a three-screen display system 20 are shown. The system 20 includes two work screens 22 and 24, and one advertisement screen 26. In the embodiment shown, the advertisement screen 26 faces in the opposite direction that work screen 22 and 24 face. The advertisement screen 26 can be docked in a docking station 28 disposed behind the system 20. For this purpose, the back of the advertising screen 26 includes a complimentary mating unit 30 that engages with the docking station 28. The docking station 28 and the mating unit 30 can be similar to those taught by Jerry Moscovitch in U.S. Pat. No. 6,702,604, the entire contents of which is incorporated herein by reference. In particular, the docking station 28 allows for quick connect and release capabilities with the mating unit 30, and allows electrical connections to be established when docking occurs.

The advertisement screen 26 can be completely dedicated to advertising or only partially dedicated to advertisement, both physically and temporally. Parts of the screen not used for advertising can be used for any other purpose by a user of the system 20. Likewise, when no advertisement is being shown, the user may also use the advertisement screen 26 for whatever purpose. When no advertisement is being shown, the advertisement screen 26 may optionally be removed by disengaging the docking station 28 and the mating unit 30.

It should be understood that in some embodiments of the multi-screen display systems contemplated by the inventor, more than one screen might be an advertisement screen. For example, in a four-screen display system, two of the four screen can be dedicated to advertising.

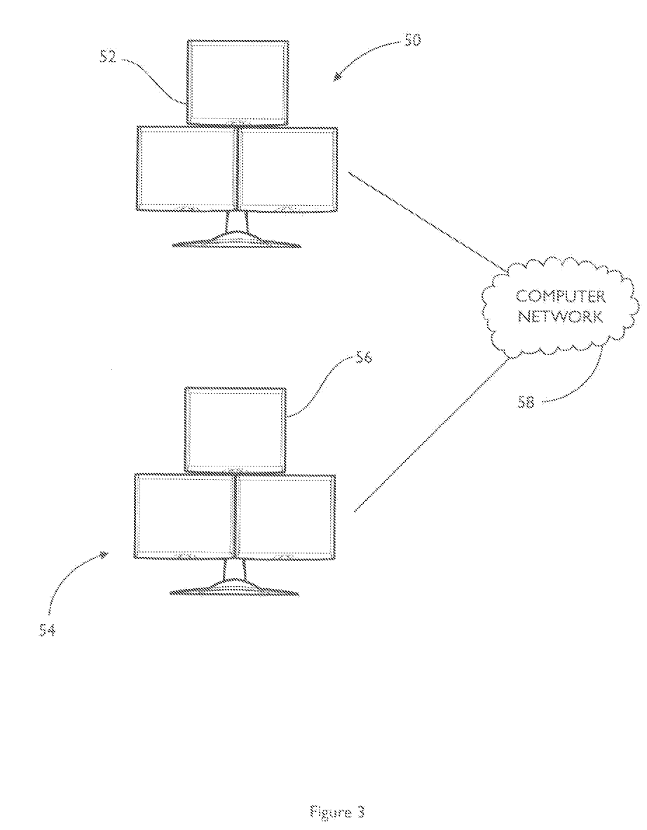

In the above examples, advertisements are shown on at least one screen of a multi-screen display system. The advertisement screen can advantageously be connected to a computer network, such as the Internet. Referring to FIG. 3, an advertising system is shown in accordance with the principles of the present invention. A first multi-screen display system 50 having one partially or completely dedicated first advertisement screen 52, and a second multi-screen display system 54 having one partially or completely dedicated second advertisement screen 56 are shown schematically. The first multi-screen display system 50 and the second multi-screen display system 54 may be at different locations, such as at a call center of a computer distributor, and at a call center of a furniture distributor. The two system 50 and 54 are connected to a computer network 58, such as the Internet.

By connecting the systems 50 and 54 to the computer network 58, advertisements shown on the respective advertisement screens 52 and 56 can be particularly tailored to a targeted audience. Thus, it is possible for an outside party to create advertising content appropriate for both the computer call center and the furniture call center, and to send the corresponding content over the Internet to the respective advertisement screens 52 and 56.

Multi-screen systems, by definition, have a surfeit of display surface and therefore present a unique opportunity to be used to show advertisements. In addition to the above models for generating revenue, the inventor contemplates any model in which at least one advertisement screen of such a system is dedicated, partially or completely, to showing advertisements, and in which an advertisers pays a beneficiary a fee therefor. The term “fee” can be understood to mean anything of value. The embodiments described above are exemplary only and are not meant to limit the scope of the invention, which is defined by the following claims.

What is claimed is:

1. A method of generating advertising revenue using a multi-screen display system, the method comprising:
providing a multi-screen display system having a plurality of screens;
dedicating an advertisement screen, chosen from the plurality of screens, for showing an advertisement; and
showing an advertisement on at least part of the advertisement screen for at least some of the time the advertisement screen is on or in use.

2. The method of generating revenue of claim 1, further comprising collecting revenue from an advertiser for showing the advertisement.

3. The method of claim 1, wherein the step of dedicating includes preventing an unauthorized person from removing the advertisement from the at least part of the advertisement screen for the at least some of the time during which the advertisement is showing.

4. The method of claim 3, further comprising authorizing a person to remove the advertisement from the at least part of the advertisement screen for the at least part of the time by issuing a password to the person.

5. The method of claim 1, wherein the advertisement screen faces in a generally opposite direction to at least one other of the plurality of screens.

6. The method of claim 1, further comprising rotating the advertisement screen when the advertisement is showing.

7. A method of generating advertisement revenue, comprising
providing a multi-screen display system having a plurality of screens to a call center having at least one salesperson for selling a product; and
on at least one advertisement screen chosen from among the plurality, showing an advertisement for the product to at least one salesperson of the call center.

8. The method of claim 7, wherein the call center is controlled by a distributor and the product is manufactured by a manufacturer, the method further comprising the manufacturer of the product paying an advertisement fee to the distributor for showing the advertisement.

9. The method of claim 8, the method further comprising a manufacturer of the multi-screen display system receiving an advertisement fee as a result of the advertisement being shown.

10. The method of claim 9, further comprising, in consideration for receiving the advertisement fee, the manufacturer of the multi-screen display system offering a discount to the to the distributor.

11. A method of generating advertising revenue using a multi-screen display system, the method comprising:
installing a multi-screen display system at a retail store, the multi-screen display system having a plurality of screens;
dedicating an advertisement screen, chosen from the plurality of screens, for showing an advertisement; and
showing an advertisement to persons in the retail store on at least part of the advertisement screen for at least some of the time the advertisement screen is on or in use.

12. The method of claim 11, wherein the retail store sells multi-screen display systems, and the multi-screen display screen having the advertisement screen is a demonstration model.

13. The method of claim 11, further comprising collecting consideration from an advertiser for showing the advertisement.

14. The method of claim 13, wherein at least a portion of the consideration is provided to a retailer owning the retail store.

15. The method of claim 14, the method further comprising: if the advertiser is a supplier of goods or services to the retail store, providing at least a portion of the consideration in the form of a discount to the retailer of the goods and services.

16. The method of claim 14, further comprising providing another portion of the consideration to a manufacturer or a distributor of the multi-screen display system.

17. The method of claim 16, further comprising: in return for receiving the other portion of the consideration, the manufacturer or distributor selling at a discount at least one multi-screen display system to the retailer.

18. The method of claim 11, further comprising
connecting the multi-screen display system to a computer network; and
sending instructions via the network to the multi-screen display system to control the content of the advertisement.

19. The method of claim 11, further comprising authorizing a person to remove the advertisement from the at least part of the advertisement screen for the at least part of the time by issuing a password to the person.

20. The method of claim 11, where in the advertisement screen faces in a generally opposite direction to at least one other of the plurality of screens.
